(19) United States
(12) Patent Application Publication
(10) Pub. No.: US 2007/0132873 A1
(43) Pub. Date: Jun. 14, 2007

(54) Portable instrument and digital camera

(75) Inventor: Manabu Hyodo, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/635,537

(22) Filed: Dec. 8, 2006

(30) Foreign Application Priority Data
Dec. 8, 2005 (JP) 2005-354904
Dec. 8, 2005 (JP) 2005-354905
Dec. 8, 2005 (JP) 2005-354906

(51) Int. Cl. H04N 5/222

(52) U.S. Cl. 348/333.01

(57) ABSTRACT

A digital still camera includes plural input buttons operable externally. A function assignment table memory stores a function assigning data table of relationship data between an operation mode, and existence or lack of a function or function information of a function predetermined respectively with the input buttons. The operation mode is constituted by a combination of one or more functions among plural functions. There is a CPU for control in the function according to one of the input buttons being operated. Plural electroluminescent (EL) display devices are disposed in association with respectively the input buttons. A display control unit causes one of the EL display devices of a specified function being assigned specifically according to the function assigning data table to display information of the specified function, and sets one of the EL display devices of a remaining function inactive among the functions.

### BACKGROUND OF THE INVENTION

1. Field of the Invention

The present invention relates to a portable instrument and digital camera. More particularly, the present invention relates to a portable instrument and digital camera in which input units are incorporated, and can have a simple structure and high operability.

2. Description Related to the Prior Art

A keypad assembly is known as a user interface for inputting information as a device incorporated in an electronic instrument or portable instrument, such as a cellular phone or digital still camera. To reduce its size, various ideas have been developed. The number of input buttons of the keypad assembly is reduced. In connection, a plurality of functions are assigned to each of the input buttons. In the digital still camera, operation modes including a photographing mode and playback mode are changed over. In response to this, the functions of the input buttons in the assigned are changed over. Also, a visible alphanumeric character or indicia is printed on a surface of the input buttons to indicate an assigned one of the functions to the input buttons. This is for a user to recognize the functions without errors.

However, there is a problem in that the alphanumeric character or indicia will be complicated and become difficult to recognize apparently. JP-A 10-027053 discloses a technique in which a touch panel is used and the alphanumeric character or indicia are displayed in a selective manner. The indication of the touch panel is sufficiently simple for easy recognition, because the alphanumeric character or indicia of only presently assigned ones of the functions are displayed.

However, the use of the touch panel has a shortcoming in that operability is low because of small response in the manual touch. The touch panel of JP-A 10-027053 has a large size unlike that of the input buttons, and will raise an amount of electrical power required for driving. Furthermore, recognition of the alphanumeric character or indicia of the functions on the input buttons may be less easy if the input buttons is placed under much illumination.

### SUMMARY OF THE INVENTION

In view of the foregoing problems, an object of the present invention is to provide a portable instrument and digital camera in which input units are incorporated, and can have a simple structure and high operability.

Another object of the present invention is to provide a portable instrument and digital camera in which input units can be recognized easily when a user views for manual operation.

In order to achieve the above and other objects and advantages of this invention, a portable instrument in which plural operation modes are selectively settable includes a plurality of externally operable input units. A function assignment table memory stores a function assigning data table of relationship data between an operation mode, and a function assigned respectively to the input units among plural functions. There is a controller for control in the function associated by the operation modes with one of the input units being operated according to the function assigning data table. A plurality of display devices are disposed in association with respectively the input units. A display control unit is responsive according to the function assigning data table, for causing one of the display devices associated with one of the input units to display information related to the function if the function is assigned thereto, and for keeping inactive a remaining one of the display devices associated with a remaining one of the input units if the remaining input unit is distinct from input units assigned with the functions.

Furthermore, a selector designates the operation mode selected among operation modes. The display control unit refers to the function assigning data table according to the selected operation mode, to read the assigned function.

Furthermore, an image sensor outputs an image signal by photoelectrically converting object light of an object.

Each of the input units includes a button block, shiftable between an open position and a closed position defined deeper than the open position, and having an outer surface where one of the display devices is positioned. A detection switch detects shifting of the button block to the closed position.

Each of the input units further includes a support mechanism for supporting the button block shiftably between the open and closed positions. A bias mechanism biases the button block toward the open position.

The display devices are electroluminescent (EL) display devices.

Furthermore, a monitor panel displays information of the operation mode.

The display control unit causes the display devices to display information, and changes brightness of the display devices according to the operation mode.

There are a normal operation mode and a power saving mode, and the display control unit changes over the display devices to set brightness of displaying of the display devices in the power saving mode lower than brightness of displaying of the display devices in the normal operation mode.

Furthermore, a mode selector is responsive when an unchanged state continues for a predetermined time in a normal operation mode, for setting the power saving mode.

The information is constituted by alphanumeric character information or indicia related to the function and a background image disposed therewith. The display control unit inverts brightness between the alphanumeric character information or indicia and the background image when the power saving mode is set instead of the normal operation mode.

In one preferred embodiment, furthermore, a brightness detecting sensor detects brightness of a field with ambient light. The display control unit causes the display devices to display the information, and adjusts brightness of displaying of the display devices according to the detected brightness of the field.

The brightness detecting sensor is constituted by an image sensor.

The information is constituted by alphanumeric character information or indicia related to the function and a background image disposed therewith. The display control unit changes over brightness of at least one of the alphanumeric character information or indicia and the background image.

Furthermore, a brightness adjuster is externally operable, for adjusting brightness of displaying of the display devices.

Also, a digital camera has an image sensor for outputting an image signal by photoelectrically converting object light of an object. There are a plurality of externally operable input units. A function assignment table memory stores a function assigning data table of relationship data between an operation mode, and existence or lack of a function or function information of a function predetermined respectively with the input units, the operation mode being constituted by a combination of one or more functions among plural functions. There is a controller for control in the function associated with one of the input units being operated according to the function assigning data table. A plurality of display devices are disposed in association with respectively the input units. A display control unit causes one of the display devices of a specified function being assigned specifically according to the function assigning data table to display information of the specified function, and sets one of the display devices of a remaining function inactive, the remaining function being among the functions and distinct from the specified function.

The display control unit causes each one of the display devices to display the information, and adjusts brightness of displaying of the display devices according to the operation mode.

Furthermore, a brightness detecting sensor detects brightness of a field with ambient light. The display control unit causes the display devices to display the information, and adjusts brightness of displaying of the display devices according to the detected brightness of the field.

The brightness detecting sensor is constituted by the image sensor.

A portable instrument includes a plurality of externally operable. input units of which a function assigned according to an operation mode is changeable. A plurality of display devices are disposed on a surface of respectively the input units. A display control unit causes each one of the display devices of a specified function being assigned specifically to display information of the specified function, and adjusts brightness of displaying of the display devices according to the operation mode.

Also, a portable instrument includes a plurality of externally operable input units of which a function assigned according to an operation mode is changeable. A plurality of display devices are disposed on a surface of respectively the input units. A brightness detecting sensor detects brightness of a field with ambient light. A display control unit causes each one of the display devices of a specified function being assigned specifically to display information of the specified function, and adjusts brightness of displaying of the display devices according to the detected brightness of the field.

In addition, a user interface includes a plurality of externally operable input regions. There is relationship data predetermined between an operation mode, and existence or lack of a function or function information of a function predetermined respectively with the input regions. A plurality of display regions are disposed in association with respectively the input regions. The display regions include a first display region, associated with an input region of a specified function being assigned specifically according to the operation mode, for displaying information of the specified function. A second display region is associated with an input region of a remaining function, for being set inactive, the remaining function being among the functions and distinct from the specified function.

### BRIEF DESCRIPTION OF THE DRAWINGS

The above objects and advantages of the present invention will become more apparent from the following detailed description when read in connection with the accompanying drawings, in which:

FIG. 1 is a perspective view illustrating a digital still camera;

FIG. 2 is a rear elevation illustrating the digital still camera;

FIG. 3 is a cross section illustrating an input button;

FIG. 4 is an explanatory view in plan illustrating a monitor display panel;

FIG. 5 is a block diagram schematically illustrating the digital still camera;

FIG. 6 is a table illustrating relationships between operation modes and groups of functions for input buttons;

FIG. 7 is a block diagram schematically illustrating a mechanism for driving each input button;

FIG. 8 is a flow chart illustrating control of a display control unit;

FIG. 9 is a rear elevation illustrating a state of display devices in a photographing mode;

FIGS. 10 and 11 are rear elevations illustrating states of the display devices in a playback mode;

FIG. 12 is a rear elevation illustrating a state of the display devices in a menu mode;

FIG. 13 is a front elevation illustrating a camera built-in cellular phone;

FIG. 14 is a front elevation illustrating a state of display devices in a photographing mode;

FIGS. 15 and 16 are front elevations illustrating states of the display devices in a playback mode;

FIG. 17 is a front elevation illustrating a state of the display devices in a communicating mode;

FIG. 18 is a front elevation illustrating a state of the display devices in a mailing mode;

FIG. 19 is a block diagram schematically illustrating one preferred digital still camera;

FIG. 20 is a block diagram schematically illustrating relationships between operation modes and groups of functions for input buttons;

FIG. 21 is an explanatory view in plan illustrating a menu screen region for adjusting brightness of the display devices;

FIG. 22 is an explanatory view in plan illustrating control of brightness according to one example;

FIGS. 23A and 23B are explanatory views illustrating an initial state of the display device with an indicia, and a brightness inverted state;

FIGS. 23C-23H are explanatory views illustrating initial states of the display device with indicia for various brightness levels, and a brightness inverted state;

FIG. 24 is a block diagram schematically illustrating another preferred digital still camera;

FIG. 25 is a table illustrating values of weighting for split zones of photometry; and

FIG. 26 is an explanatory view in plan illustrating a menu screen region for adjusting brightness of the display devices.

### DETAILED DESCRIPTION OF THE PREFERRED EMBODIMENT(S) OF THE PRESENT INVENTION

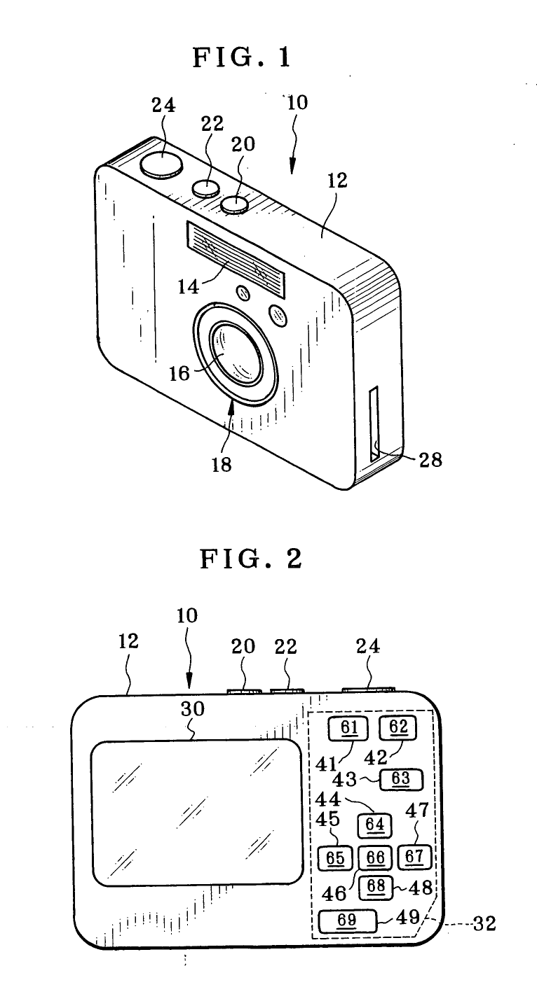

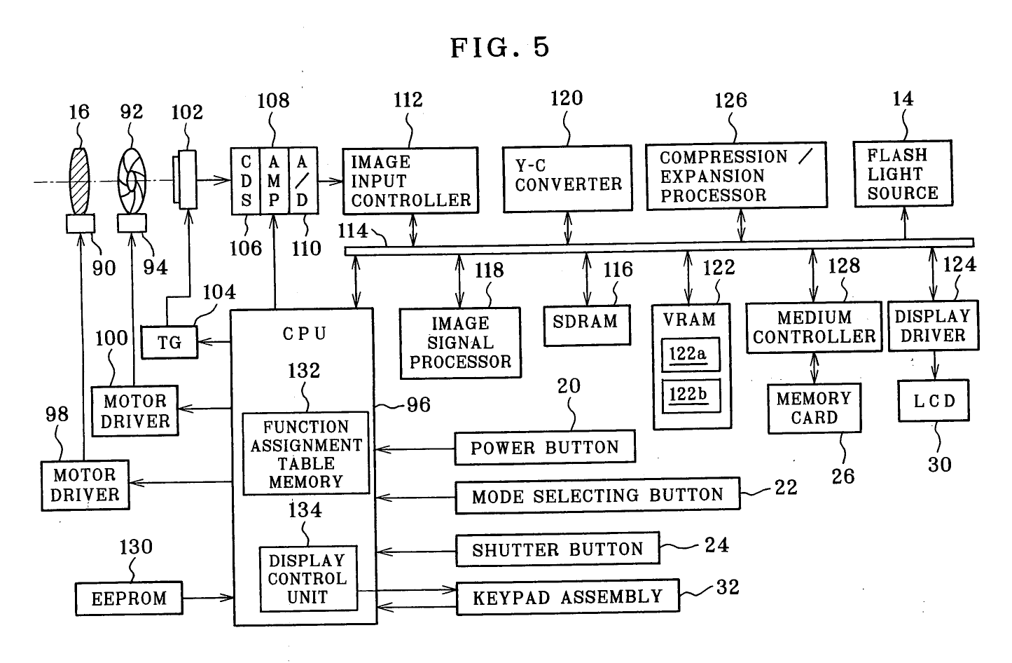

In FIGS. 1 and 2, a digital still camera 10 as portable instrument has a camera body 12. Elements on a front of the camera body 12 include a flash light source 14 and a lens barrel 18. A photographing lens 16 is mounted in the lens barrel 18. Elements on an upper face of the camera body 12 include a power button 20, a mode selecting button 22 or selector, and a shutter button 24. The power button 20 is operable to turn on and off the power. The mode selecting button 22 is operated for setting a selected one of modes which are a photographing mode, playback mode, and menu mode. A slot lid 28 is associated with a lateral face of the camera body 12. A memory card 26 of FIG. 5 is removably inserted in a memory card slot in the camera body 12. The slot lid 28 covers the memory card slot.

The shutter button 24 is a switch of a two step depressible structure. When the shutter button 24 is halfway depressed, a first step switch is turned on, so the digital still camera 10 operates for the AF and AE operation to stand by for image pickup. When the shutter button 24 is fully depressed, a second step switch is turned on. An image signal of one image frame in a state ready for photographing is converted to image data, which is processed by image processing and compressed, and is written to the memory card 26.

A rear face of the camera body 12 has an LCD monitor display panel 30 and a keypad assembly 32 as a user interface. In a photographing mode, the monitor display panel 30 displays a live image. In a playback mode, the monitor display panel 30 displays a stored image from the memory card 26. In the menu mode, a menu screen region is displayed by the monitor display panel 30 for entry of any of various settings.

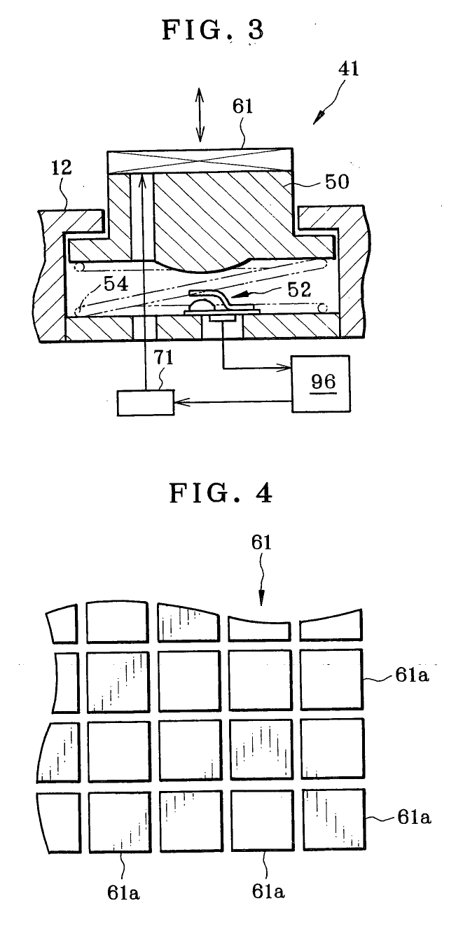

In the keypad assembly 32 are arranged a plurality of input buttons 41, 42, 43, 44, 45, 46, 47, 48 and 49 as operable input units or input regions. In FIG. 3, the input button 41 includes a depressible button block 50 and a detection switch 52 disposed at an inner point of the button block 50. A compression coil spring 54 as biasing mechanism biases the button block 50 toward an open position where the button block 50 is the farther from the detection switch 52. The button block 50, when depressed and moved to a closed position against the compression coil spring 54, turns on the detection switch 52 to input a detection signal to the camera body 12.

An organic electroluminescent (EL) display device 61 or display region in a user interface is attached to a surface of the button block 50 in the input button 41. In FIG. 4, pixels 61a are arranged in a matrix form. The display device 61 is a dot matrix type having the pixels 61a. A display driver 71 drives the display device 61. At each of the pixels 61a, a light emitting element illuminates at a brightness according to applied voltage. The display driver 71 changes voltage applied to the pixels 61a, to form an image by changing brightness of the pixels. Examples of driving methods for the display device 61 include a passive matrix method and active matrix method which are different in the application of voltage. Any one of those can be selected.

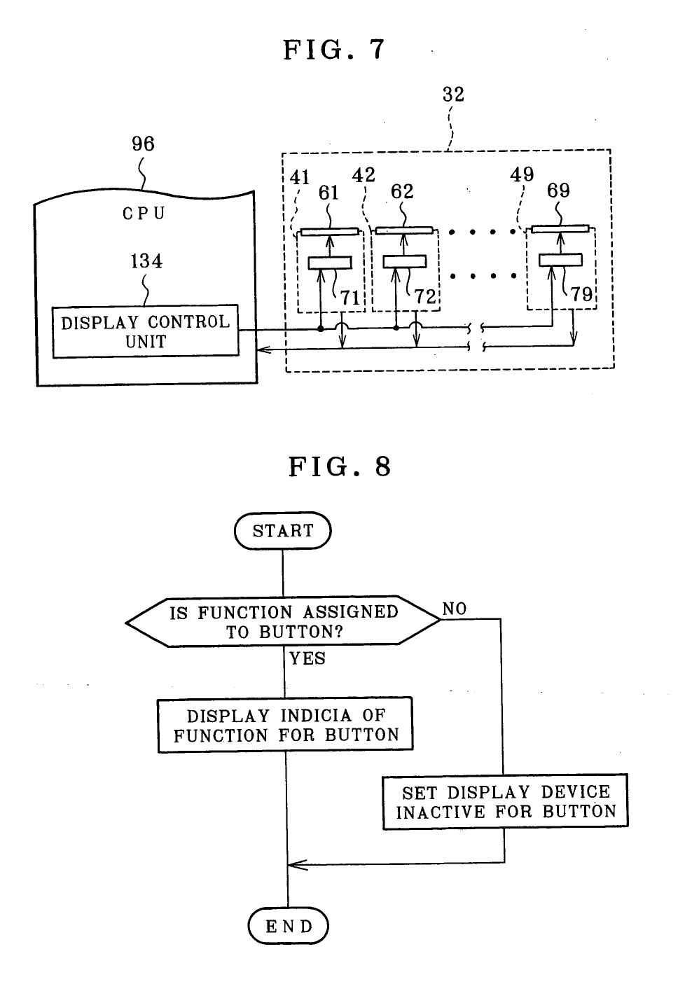

Also, each of the input buttons 42-49 has a button block and a detection switch. A detection signal is generated by depression of the input buttons 42-49 and sent to the camera body 12. In FIG. 2, organic electroluminescent (EL) display devices 62, 63, 64, 65, 66, 67, 68 and 69 as display regions are attached to respectively surfaces of the input buttons 42-49. Display drivers 72, 73, 74, 75, 76, 77, 78 and 79 of FIG. 7 drive the display devices 62-69, to display images.

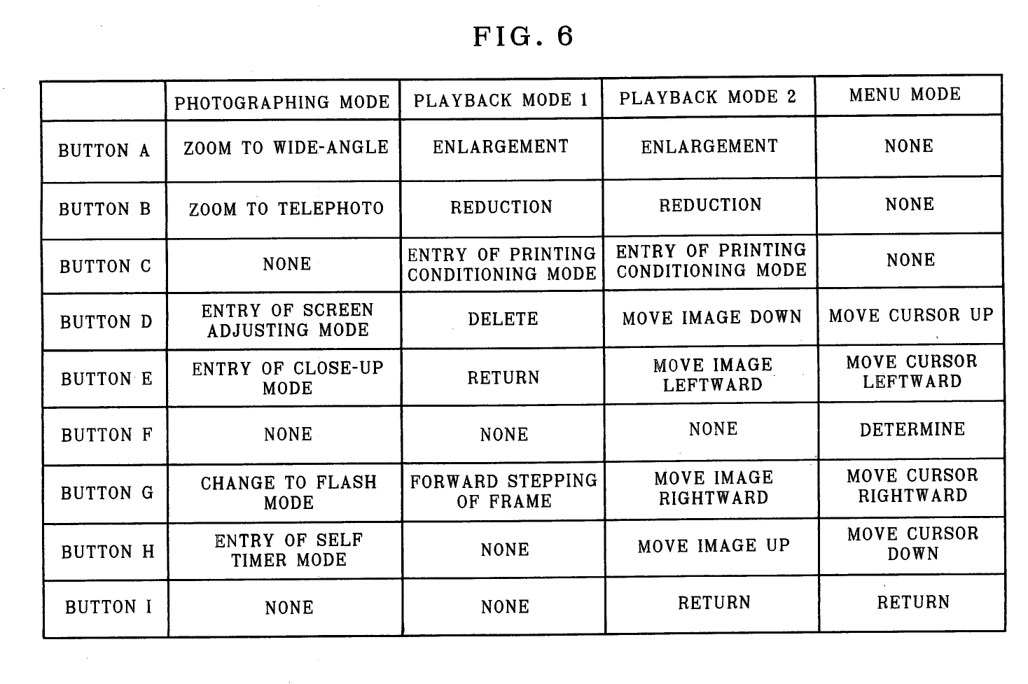

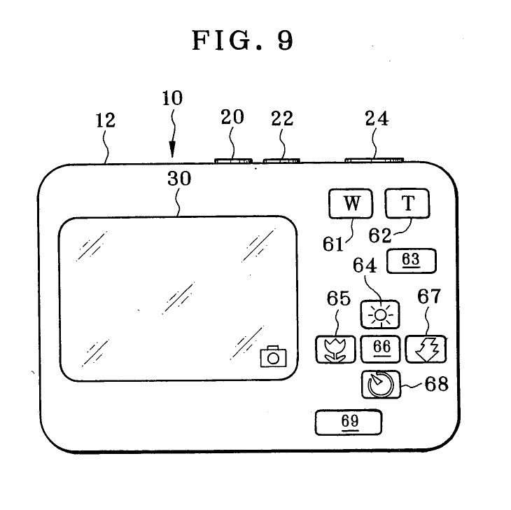

In FIG. 6, the function of the input buttons 41-49 is changeable according to the operation mode of the digital still camera 10. In the photographing mode, the input buttons 41 and 42 are assigned to zooming by changing a zoom magnification. The input button 44 is assigned to setting a screen adjusting mode to adjust brightness of the monitor display panel 30. The input button 45 is assigned to setting a close-up photographing mode. The input button 47 is assigned to changing over the flash mode. The input button 48 is assigned to setting a self timer mode in which a self timer is used in image pickup. See FIG. 9.

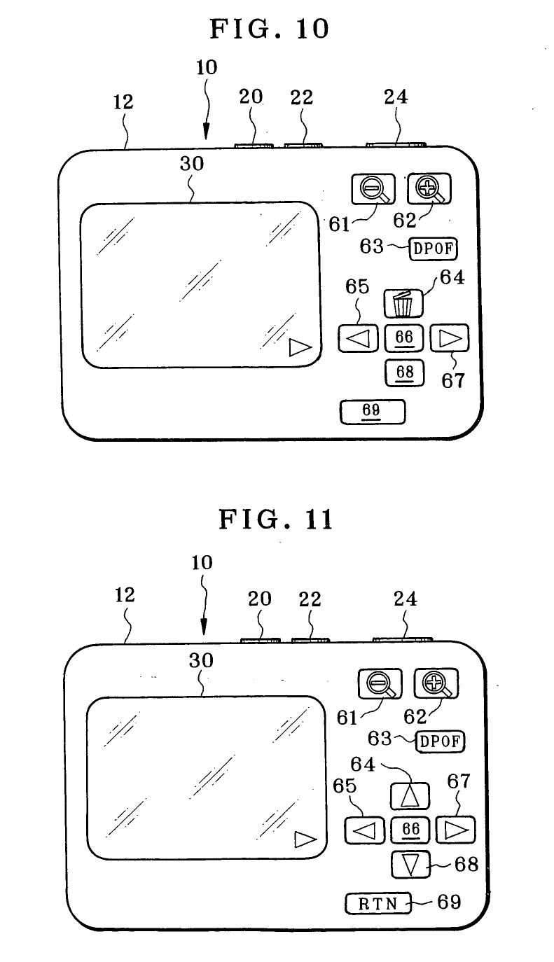

In the playback mode, the input buttons 41 and 42 are assigned to enlargement and reduction of a playback image. The input button 43 is assigned to setting a printing conditioning mode for designating a condition of printing of stored image data. The input button 44 is assigned to deleting the playback image. The input buttons 45 and 47 are assigned to returning or stepping forwards of image frames of playback images. See FIG. 10. When the playback image is enlarged over the size of the monitor display panel 30 in the playback mode, the input buttons 44, 45, 47 and 48 are enabled and operate for shifting a display region of a partial playback image. The input button 49 is assigned to canceling the enlargement and reduction. See FIG. 11.

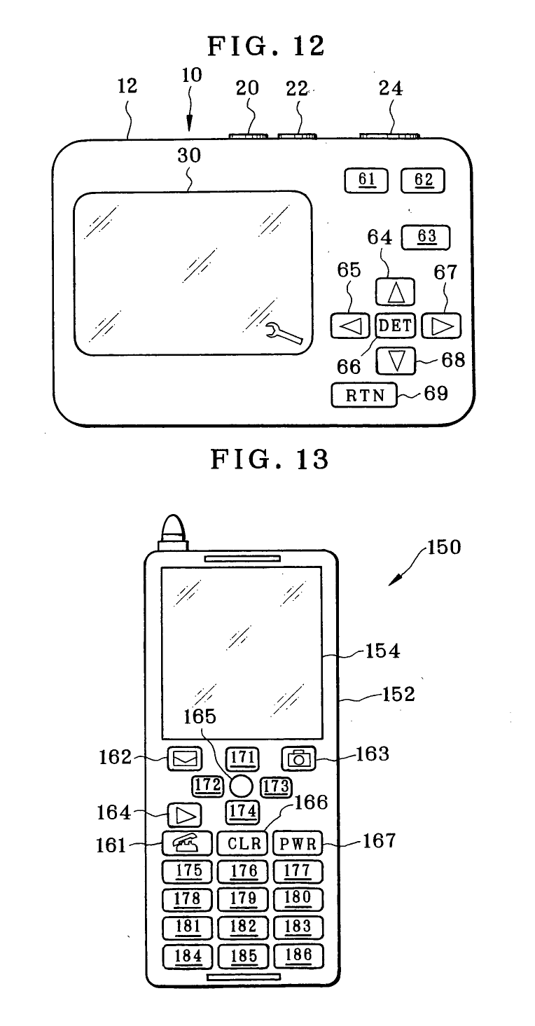

In the menu mode, the input buttons 44, 45, 47 and 48 are enabled and operate for shifting a cursor within a menu screen region. The input button 46 is assigned to determining an item specified by positioning the cursor. The input button 49 is assigned to returning to a previous screen region shortly before the present screen region. See FIG. 12.

This being so, the total number of the input buttons is reduced by assigning a plurality of functions to each one of those. The digital still camera 10 can have a reduced size. Of course, it is possible to change the number, arrangement and assignment of the input buttons in any suitable manner distinct from the above.

In FIG. 5, a lens motor 90 is connected with the photographing lens 16 and included in various circuits of the digital still camera 10. There is an iris mechanism or aperture stop mechanism 92, with which an iris motor 94 is connected. Both of the lens motor 90 and the iris motor 94 are stepping motors. Motor drivers 98 and 100 are connected with a CPU 96 as controller, and generate drive pulses to drive the lens motor 90 and the iris motor 94. When the shutter button 24 is halfway depressed, the lens motor 90 and the iris motor 94 rotate to stand by for image pickup.

The lens motor 90 responds to a command signal for zooming, and moves a zoom lens/lens group of the photographing lens 16 to one of the wide-angle end or telephoto end. Also, a focus lens/lens group within the photographing lens 16 is moved according to zooming, and adjusts the focusing to optimize a condition of the image pickup. The iris motor 94 moves the iris mechanism 92 for adjusting the aperture stop.

A CCD 102 as image sensor or brightness detecting sensor is disposed behind the photographing lens 16, and receives and detects object light passed through the photographing lens 16 to photograph an image. A timing generator (TG) 104 is connected by the CCD 102 and controlled by the CPU 96. A clock pulse or timing signal is generated by the timing generator 104, and determines a shutter speed of the electronic shutter.

A correlated double sampling circuit (CDS) 106 is supplied with an image signal from the CCD 102, and outputs image data of red, green and blue colors exactly corresponding to an amount of stored change in each of cells of the CCD 102. An amplifier 108 amplifies the image data from the correlated double sampling circuit 106. An A/D converter 110 converts the amplified image data into digital image data.

There is an image input controller 112. A data bus 114 is connected with the CPU 96. The image input controller 112 is controlled by the CPU 96 through the data bus 114, to control the CCD 102, the correlated double sampling circuit 106, the amplifier 108 and the A/D converter 110. An SDRAM 116 is supplied with image data output by the A/D converter 110, and stores the image data in a temporary manner.

An image signal processor 118 reads image data from the SDRAM 116, and subjects the image data to image processing of such items as gradation conversion, white balance adjustment, gamma conversion and the like. The image data is written to the SDRAM 116 in a rewriting manner. A Y-C converter 120 reads the processed image data from the SDRAM 116 after processing in the image signal processor 118, and converts the image data into a brightness signal Y and color difference signals Cr and Cb.

A VRAM 122 is a data storage for outputting a live image to the monitor display panel 30, and stores image data after being processed by the image signal processor 118 and the Y-C converter 120. Frame memories 122a and 122b for two frames are included in the VRAM 122 for simultaneously writing and reading image data. A display driver 124 is supplied with the image data read from the VRAM 122, and converts the image data into a composite signal of an analog form, for the monitor display panel 30 to display a live image.

A compression/expansion processor 126 processes image data in the compression in a predetermined format of compression, for example JPEG (Joint Photographic Experts Group) format after Y-C conversion in the Y-C converter 120. A medium controller 128 is supplied with the compressed image data, which is written to the memory card 26.

The CPU 96 controls various elements in the digital still camera 10. An EEPROM 130 stores controls programs and information of settings. The CPU 96 reads the control programs and information of settings from the EEPROM 130, writes those to the SDRAM 116 which is a work memory to drive and control the elements. Signals are generated by the shutter button 24, the mode selecting button 22, the power button 20 and the input buttons 41-49 of the keypad assembly 32, the CPU 96 being responsive to the signals for the control.

In the CPU 96 are incorporated a function assignment table memory 132 and a display control unit 134. In FIG. 6, the function assignment table memory 132 stores a function assigning data table which is a relationship between function information of functions assigned to the input buttons 41-49 which are buttons A-I in the drawing, and operation modes of the digital still camera 10. The CPU 96, in response to a signal generated by each of the input buttons 41-49, checks a present one of the plural operation modes, and refers to the function assignment table memory 132, to execute the function assigned to each one of the input buttons 41-49.

Functions of a limited number are assigned to the input buttons. There remains one or more input buttons to which no function is assigned. Thus, information of use or lack of the function assigned to the input buttons 41-49 is stored in the function assignment table memory 132.

In FIG. 7, a mechanism for driving the input buttons 41-49 is illustrated. The display control unit 134 is connected with the display drivers 71-79 to drive the EL display devices 61-69. The display control unit 134 controls the display drivers 71-79 to cause the display devices 61-69 to display an image.

In FIG. 8, the display control unit 134 operates according to the present operation mode being set and the function assigning data table of the function assignment table memory 132, and checks the use or lack of the function of the input buttons 41-49 and the function information of the functions of those among all functions. If there is a function assigned to an input button, a display device combined with the input button is driven to display an indicia for expressing the function visually. If no function is assigned to an input button, a display device combined with the input button is turned off and kept inactive.

In FIG. 9, the display control unit 134 in the photographing mode causes the EL display devices 61 and 62 to display a function indicia for zooming by changing a zoom magnification. The display control unit 134 causes the display device 64 to display a function indicia for setting a screen adjusting mode. The display control unit 134 causes the display device 65 to display a function indicia for setting a close-up photographing mode. The display control unit 134 causes the display device 67 to display a function indicia for changing over the flash mode. The display control unit 134 causes the display device 68 to display a function indicia for setting a self timer mode in which a self timer is used in image pickup. The display control unit 134 also keeps the display devices 63, 66 and 69 inactive, because of no assignment of the function. The CPU 96 actuates the display driver 124 to cause the monitor display panel 30 to display the present mode or the photographing mode in the digital still camera 10.

In FIG. 10, the display control unit 134 in the playback mode causes the EL display devices 61 and 62 to display a function indicia for enlarging and reducing a playback image. The display control unit 134 causes the display device 63 to display a function indicia for setting a printing conditioning mode for designating a condition of printing of stored image data. The display control unit 134 causes the display device 64 to display a function indicia for deleting an image. The display control unit 134 causes the display devices 65 and 67 to display a function indicia for stepping forwards and returning of image frames of playback images. The display control unit 134 also keeps the display devices 66, 68 and 69 inactive, because of no assignment of the function. The CPU 96 actuates the display driver 124 to cause the monitor display panel 30 to display the present mode or the playback mode in the digital still camera 10.

If the playback image is enlarged over a size of the monitor display panel 30 in the playback mode, the display control unit 134 in FIG. 11 causes the display devices 64, 65, 67 and 68 to display a function indicia for movement in a selected one of upward, downward, leftward and rightward directions. The display control unit 134 causes the display device 69 to display a function indicia for canceling enlargement or reduction of the playback image. Also, the display control unit 134 keeps the display device 66 inactive without driving, because of lack of assignment of a function.

In FIG. 12, the display control unit 134 in the menu mode causes the display devices 64, 65, 67 and 68 to display a function indicia for movement in a selected one of upward, downward, leftward and rightward directions. The display control unit 134 causes the display device 66 to display a function indicia for determining an item specified by positioning the cursor. The display control unit 134 causes the display device 69 to display a function indicia for returning to a previous screen region shortly before the present screen region. The display control unit 134 also keeps the EL display devices 61, 62 and 63 inactive, because of their lack of assignment of the function. The CPU 96 actuates the display driver 124 to cause the monitor display panel 30 to display the present mode or the menu mode in the digital still camera 10.

Accordingly, the digital still camera 10 can be handled easily as an advantage, because indicia can be displayed in a display device combined with respectively an input button. This is effective in facilitating understanding of the input buttons, and facilitating handling in comparison with a touch panel. The group of the input buttons includes a number of input buttons of which no function is assigned in relation to a selected one of the operation modes. This is effective in reducing complexity in the operation. It is possible to keep one of the input buttons inactive without displaying, so as to reduce the total power of electricity.

In FIGS. 13-18, a camera built-in cellular phone is a portable instrument of the invention according to preferred embodiments. In a camera built-in cellular phone 150 of FIG. 13, operation modes are selectable, which are a communicating mode, mailing mode, camera mode and playback mode. In the communicating mode, the cellular phone 150 is used for communication by transmission and reception of sounds and voices. In the mailing mode, an electronic mail is transmitted or received. In the camera mode, an image can be photographed by a built-in camera. In the playback mode, an LCD monitor display panel 154 is caused to display the photographed image or an image according to stored image data.

A body 152 of the camera built-in cellular phone 150 has a front face where the monitor display panel 154 and a keypad are disposed. The keypad includes input buttons 161, 162, 163, 164, 165, 166 and 167, and input buttons 171, 172, 173, 174, 175, 176, 177, 178, 179, 180, 181, 182, 183, 184, 185 and 186 as operable input units or input regions. Predetermined functions are assigned to respectively the input buttons 161-167. The input buttons 161-164 are mode changing buttons. When the input button 161 is depressed, a communicating mode is set. When the input button 162 is depressed, a mailing mode is set. When the input button 163 is depressed, a camera mode is set. When the input button 164 is depressed, a playback mode is set. The input button 165 operates as a release button and a determining button. The input button 166 is a clear button. The input button 167 is a power button.

Functions of the input buttons 171-186 are changeable according to a selected operation mode. Display devices are attached to respectively surfaces of the input buttons 171-186, to display function indicia of functions assigned to the input buttons 171-186.

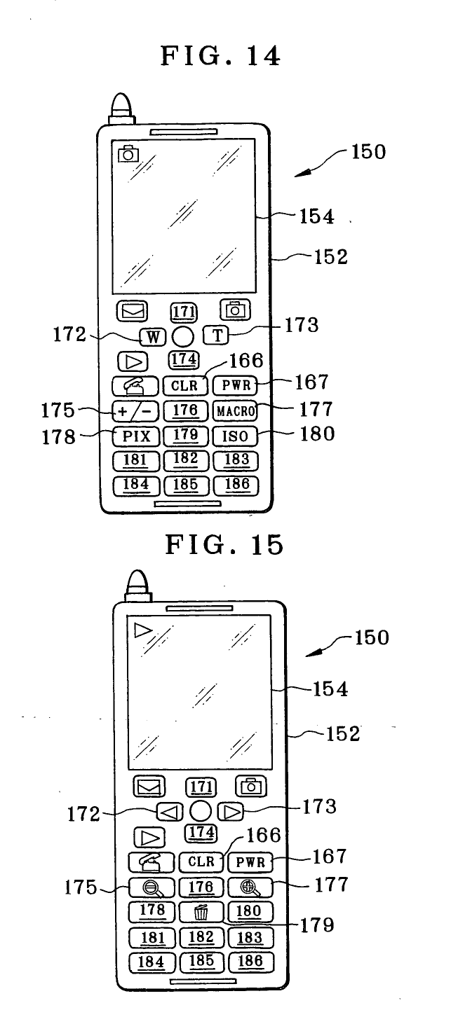

In FIG. 14, a display device of the input buttons 172 and 173 in the photographing mode displays a function indicia for zooming by changing a zoom magnification. A display device of the input button 175 displays a function indicia for setting a screen adjusting mode. A display device of the input button 177 displays a function indicia for setting a close-up photographing mode. A display device of the input button 178 displays a function indicia for selection of the number of pixels in the image pickup, examples of the number being VGA (Video Graphics Array), 1 M (1-megapixel), 2 M (2-megapixel) and 3 M (3-megapixel). A display device of the input button 180 displays a function indicia for ISO sensitivity in the image pickup, examples of the ISO sensitivity being Auto, 100, 200, 300 and 400. A display device of the input buttons 171, 174, 176, 179 and 181-186 is kept inactive without driving, because of lack of assignment of a function. The monitor display panel 154 displays a mode indicia of the photographing mode in the present setting.

In FIG. 15, the display device of the input buttons 172 and 173 in the playback mode displays a function indicia for stepping forwards and returning of image frames of playback images. The display device of the input buttons 178 and 180 displays a function indicia for enlarging and reducing a playback image. The display device of the input button 179 displays a function indicia for deleting an image. A display device of the input buttons 171, 174, 176, 178 and 180-186 is kept inactive without driving, because of lack of assignment of a function. The monitor display panel 154 displays a mode indicia of the playback mode in the present setting.

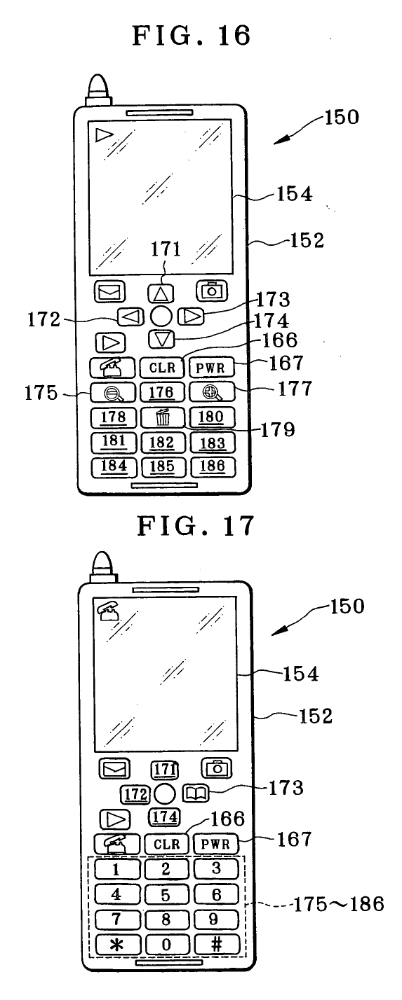

If the playback image is enlarged over a size of the monitor display panel 154 in the playback mode, the camera built-in cellular phone 150 in FIG. 16 causes the input buttons 171-174 to display a function indicia for movement of a partial image in a selected one of upward, downward, leftward and rightward directions. Also, the cellular phone 150 keeps the input buttons 176, 178 and 180-186 inactive without driving, because of lack of assignment of a function.

In FIG. 17, the display device of the input button 173 in the communicating mode displays an indicia for viewing a phone book containing telephone numbers. The display device of the input buttons 175-186 displays a function indicia for a ten key pad for inputting a telephone number. The display device of the input buttons 171, 172 and 174 is kept inactive without driving, because of lack of assignment of a function. The monitor display panel 154 displays a mode indicia of the communicating mode in the present setting.

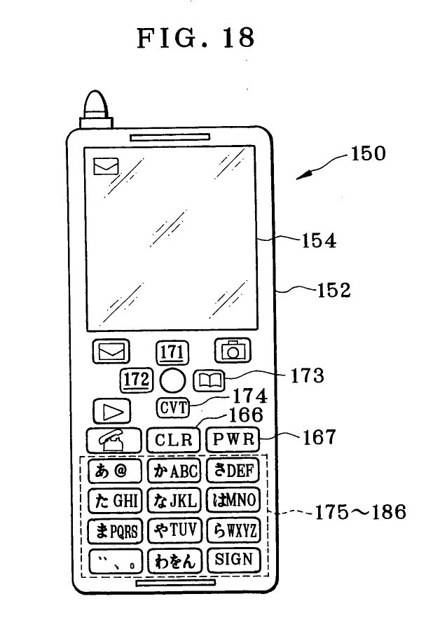

In FIG. 18, the display device of the input button 173 in the mailing mode displays an indicia for viewing an address book. The display device of the input button 174 displays a function indicia for a conversion button. The display device of the input buttons 175-186 displays a function indicia for a ten key pad for producing a message of an electronic mail. The display device of the input buttons 171 and 172 is kept inactive without driving, because of lack of assignment of a function. The monitor display panel 154 displays a mode indicia of the mailing mode in the present setting.

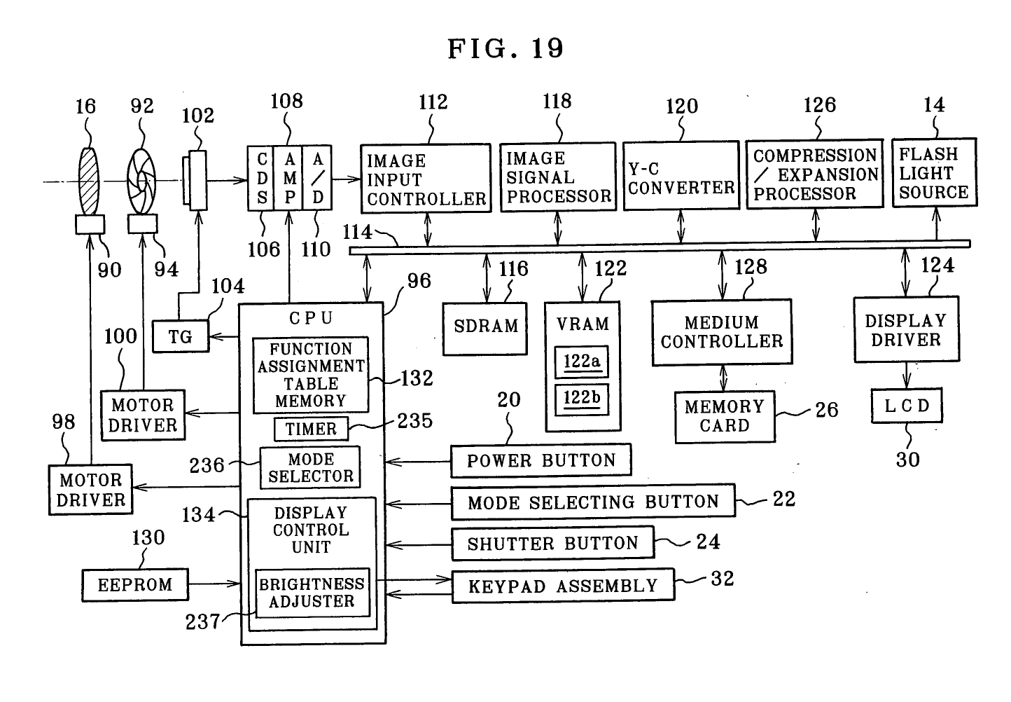

In FIGS. 19-23H, one preferred embodiment is illustrated, which is characterized in having a power saving mode. All the operation modes described above are selectable by use of the mode selecting button 22, including the photographing mode, playback mode, and menu mode. The close-up mode and the self timer mode are usable by setting in the photographing mode. The screen adjusting mode is usable by setting in the menu mode. Also, the power saving mode is selectable, and is a mode for saving power in a manner distinct from a normal state. The power is saved when the power saving mode is set. Also, if the digital still camera 10 is left to stand for a predetermined time elapses without operation in the normal state, the power saving mode is automatically set to save power.

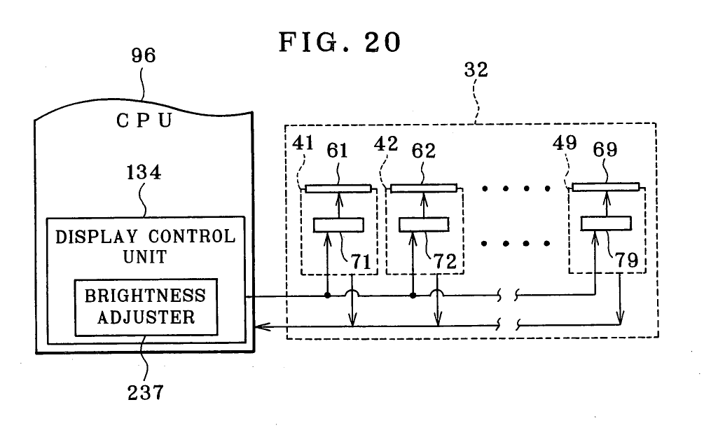

In FIG. 19, a timer 235 and a mode selector 236 is included in the CPU 96. In FIGS. 19 and 20, a brightness adjuster 237 is included in the function assignment table memory 132. The timer 235 has an oscillator for generating a clock signal at a regular interval, and measures time according to the clock signal. The timer 235 is used for producing date information of a date of photographing in combination with an image, for control of scheduling the release of the shutter in the self timer mode, and for measuring time in order to start the power saving mode.

The mode selector 236 changes over the operation mode in response to operation of the mode selecting button 22 in the normal state. Also, time of leaving to stand in the normal state without operation is measured by the timer 235, so the mode selector 236 sets the power saving mode in the digital still camera 10 if a predetermined time elapses in the normal state. Also, the mode selector 236 sets the screen adjusting mode in the digital still camera 10 if the input button 44 is operated in the photographing mode.

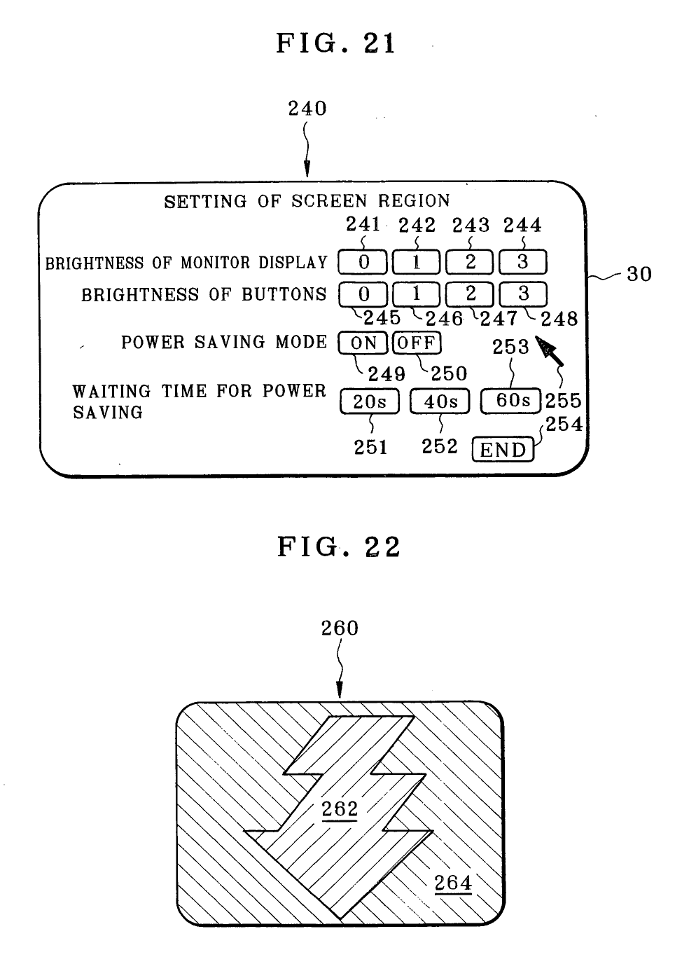

In the screen adjusting mode, an adjusting screen region 240 is displayed on the monitor display panel 30 by the CPU 96 as illustrated in FIG. 21. Various tabs or indicia are indicated in the adjusting screen region 240, including brightness adjusting tabs or indicia 241, 242, 243, 244, 245, 246, 247 and 248 as brightness adjuster for setting brightness of the monitor display panel 30 and the EL display devices 61-69 in the normal state, tabs or indicia 249 and 250 for turning on and off of the power saving mode, tabs or indicia 251, 252 and 253 for determining a length of time before setting the power saving mode without operation, a tab or indicia 254 for quitting the screen adjusting mode, and a cursor 255 for specifically selecting the tabs 241-254.

If the brightness adjusting tabs 241-244 are selected, the CPU 96 changes over the brightness of the monitor display panel 30 according to a value of a selected one of the brightness adjusting tabs 241-244 between four grades which are from the dimmest (0) to the brightest (3). If the brightness adjusting tabs 245-248 are selected, the brightness adjuster 237 changes over the brightness of the EL display devices 61-69. The brightness adjuster 237 changes over the brightness of the display devices 61-69 according to a value of a selected one of the brightness adjusting tabs 245-248 between four grades which are from the dimmest (0) to the brightest (3).

When the power saving mode is set in the digital still camera 10, the brightness adjuster 237 changes over and sets the brightness of the EL display devices 61-69 at the level 0. This is effective in saving power. The display devices 61-69 display images at a lower brightness than the normal state. Note that the purpose of the use of the power saving mode is not limited. For example, a user can set the power saving mode according to his or her preference in relation to visual appearance of the display devices 61-69 in the normal use.

To change over the brightness of the screen region, brightness of the entire screen region may be changed. However, it is possible to change brightness between predetermined zones within the screen region. In FIG. 22, a screen region 260 of the monitor display panel is split into an alphanumeric character or indicia 262 as information, and a background image 264 as information. At least one of the alphanumeric character or indicia 262 and the background image 264 is changed over. Also, contrast of an image may be higher according to the highness of the brightness level by suitably setting the brightness level of the alphanumeric character or indicia 262 and the background image 264.

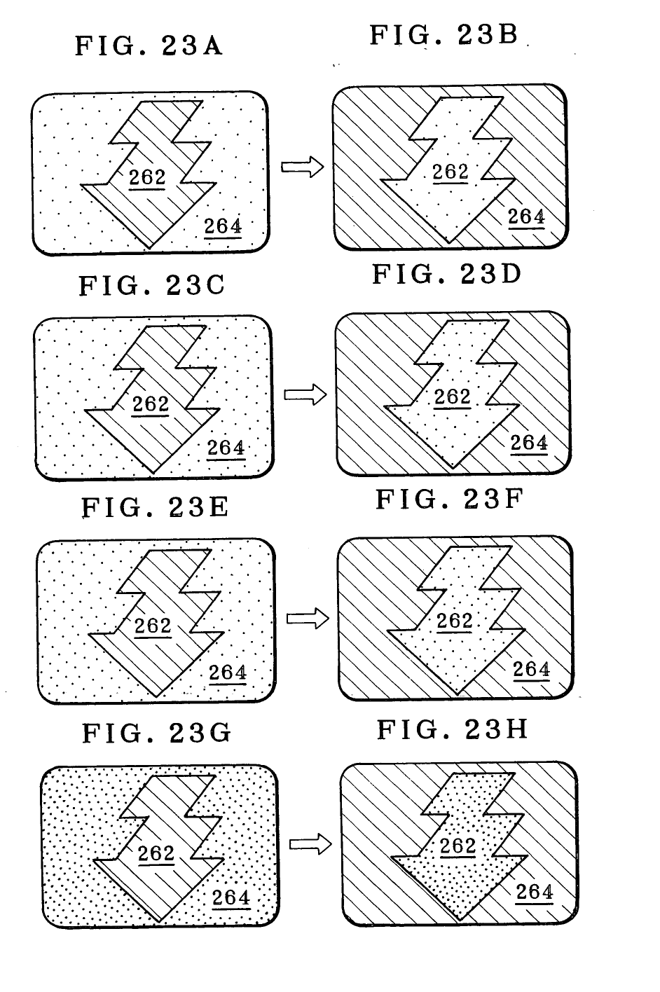

It is also preferable to invert a bright and dim pattern between the alphanumeric character or indicia 262 and the background image 264 at the same time as setting the power saving mode from the normal state. In FIGS. 23A-23H, examples are illustrated. In any of those, appearance of the alphanumeric character or indicia 262 and that of the background image 264 are distinct according to the brightness level. In the normal state, the alphanumeric character or indicia 262 is displayed in a fixed brightness level. The background image 264 is displayed in a stepwise changeable brightness level of four grades of FIGS. 23A, 23C, 23E and 23G. In FIG. 23A, the brightness level of the background image 264 is the highest. In FIG. 23G, the brightness level of the background image 264 is the lowest. A user is enabled to set a selected one of the four levels.

If the power saving mode is set in selecting the brightness level of FIG. 23A, then the bright and dim pattern is inverted between the alphanumeric character or indicia 262 and the background image 264 as illustrated in FIG. 23B. If the power saving mode is set in selecting the brightness level of FIG. 23C, then the bright and dim pattern is inverted between the alphanumeric character or indicia 262 and the background image 264 as in FIG. 23D. If the power saving mode is set in selecting the brightness level of FIG. 23E, then the bright and dim pattern is inverted between the alphanumeric character or indicia 262 and the background image 264 as in FIG. 23F. If the power saving mode is set in selecting the brightness level of FIG. 23G, then the bright and dim pattern is inverted between the alphanumeric character or indicia 262 and the background image 264 as in FIG. 23H. Thus, the inversion of the pattern is effective in the manner similar to that of the above embodiment.

In the above embodiment, the brightness of the monitor display panel is changed over according to setting of the power saving mode. However, a specific scene mode or other preference mode may be utilized to change over the brightness of the monitor display panel. For example, a specific scene mode can be a night scene mode. In general, the monitor display panel is difficult to view in an environment at night when the night scene is set. It is possible automatically to set the monitor display panel at a higher brightness in response to setting of the night scene mode in comparison with the brightness in a normal state. This is effective in facilitating the visual recognition of the monitor display panel.

Note that the contrast of the EL display devices 61-69 may be used instead of brightness of those. The contrast is adjusted according to selection of the operation modes. The contrast, if the power saving mode is set, is set lower, and if the normal operation mode is set, is set higher.

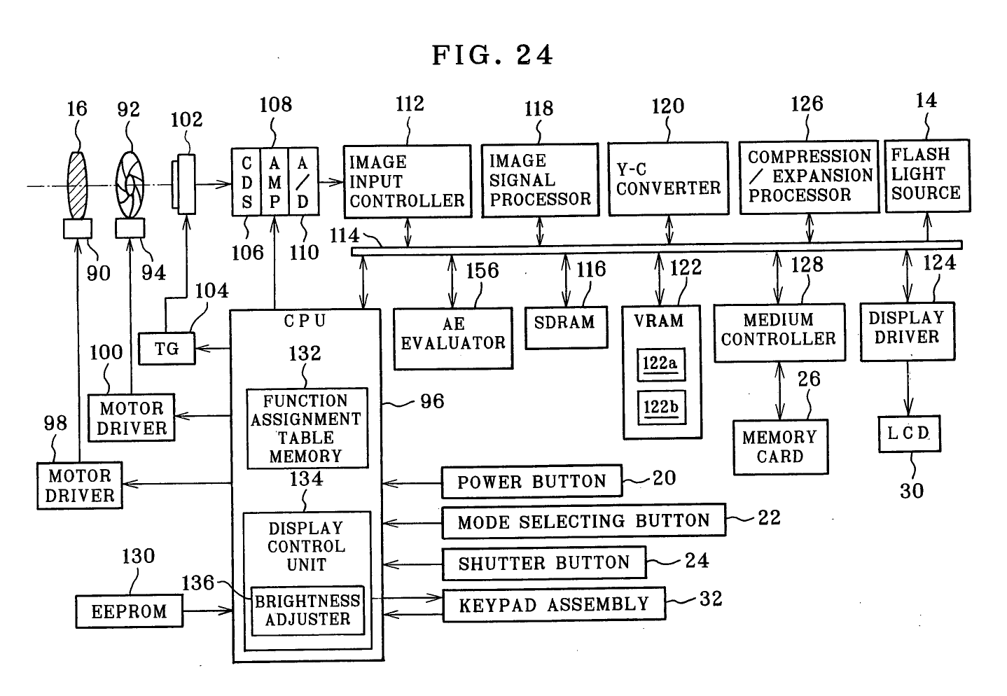

In FIGS. 24-26, other preferred embodiments are illustrated, in which adjustment of the brightness is automated. In FIG. 24, an AE evaluator 156 is connected, and receives image data read from the SDRAM 116. A photometric value Ev of brightness of an object is determined by the AE evaluator 156 according to the equation, to output information of the photometric value Ev to the CPU 96.
Ev=log₂(Σwi×2^{Evi} Σwi)−ΔEviso

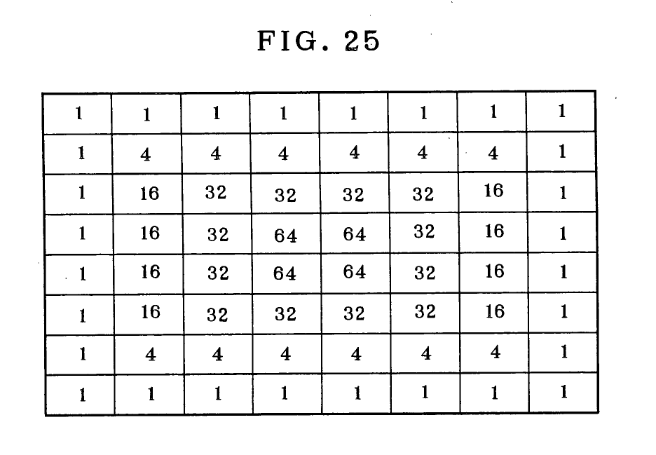

In the equation, Evi is a photometric value of each one of 64 regions into which an image frame of an image is split in FIG. 25 according to image data stored in the SDRAM 116. The value wi is a value of weight associated with the regions, and is expressed numerically in each of the regions. In the digital still camera 10, the center weighted metering method is used in which a region at the center or near the center is weighed at a higher amount. ΔEviso is a correction amount of photometry according to ISO 200.

Exposure is adjusted by the CPU 96 according to the photometric value (Ev) being determined. Zones of splitting in determining the photometric value (Ev) and values of the weight can be suitably predetermined in manners other than described above. Note that photometry or metering of light may be other than the center weighted metering, for example, multi zone metering where zones are split in an image frame and with different weights, and spot metering where only a portion of an image frame is metered.

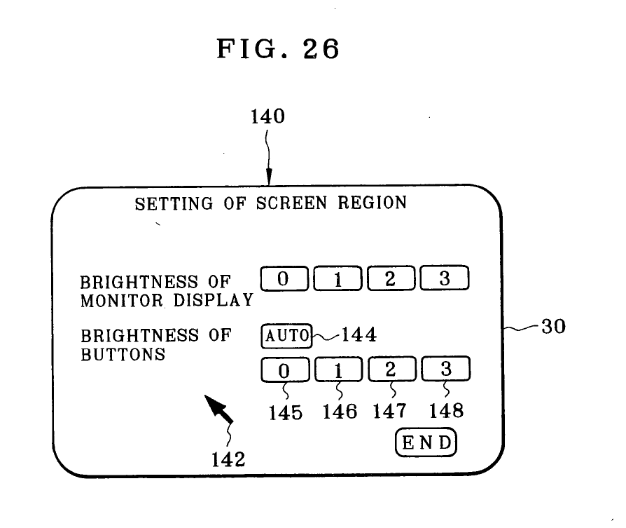

In FIG. 20, a brightness adjuster 136 is incorporated in the display control unit 134 for changing over the brightness of the EL display devices 61-69. There are two modes in which the brightness adjuster 136 operates, including an auto adjusting mode of automatically changing the brightness, and a manual adjusting mode of manually inputting the brightness by a user. When the input button 44 is operated in the photographing mode to set the screen adjusting mode, an adjusting screen region 140 of FIG. 26 is displayed on the monitor display panel 30 by the CPU 96.

A cursor 142 and a tab or indicia 144 are displayed in the adjusting screen region 140. The tab 144 is selected by shifting and positioning the cursor 142, to drive the brightness adjuster 136 in the auto adjusting mode. The brightness adjuster 136 changes over the brightness of the EL display devices 61-69 according to the photometric value (Ev) obtained by the AE evaluator 156. Levels of the brightness of the display devices 61-69 are four grades which are from the dimmest (0) to the brightest (3).

If the photometric value Ev is lower than 5 EV, then the brightness adjuster 136 sets the EL display devices 61-69 at the brightness level 0. If the photometric value Ev is equal to or higher than 5 EV and lower than 9 EV, then the brightness adjuster 136 sets the display devices 61-69 at the brightness level 1. If the photometric value Ev is equal to or higher than 9 EV and lower than 13 EV, then the brightness adjuster 136 sets the display devices 61-69 at the brightness level 2. If the photometric value Ev is equal to or higher than 13 EV, then the brightness adjuster 136 sets the display devices 61-69 at the brightness level 3.

The object is brighter according to highness of the photometric value Ev. Namely, a photographic field around the digital still camera 10 is illuminated brightly. Accordingly, the brightness level of the EL display devices 61-69 is controlled higher according to highness of the photometric value Ev, so as to facilitate recognition of the display devices 61-69 with higher brightness according to illumination in the photographic field. In contrast, the brightness level of the display devices 61-69 is controlled lower if the photographic field around the digital still camera 10 is dim. So power can be saved.

Brightness adjusting tabs or indicia 145, 146, 147 and 148 as brightness adjuster are indicated in the adjusting screen region 140. Any one of those is selectively designated by positioning the cursor 142, to drive the brightness adjuster 136 in a manual mode. The brightness adjuster 136 sets the brightness of the EL display devices 61-69 at the level 0 when the brightness adjusting tab 145 is selected. The brightness adjuster 136 sets the brightness of the display devices 61-69 at the level 1 upon selection of the brightness adjusting tab 146, at the level 2 upon selection of the brightness adjusting tab 147, and at the level 3 upon selection of the brightness adjusting tab 148. The setting of the manual mode is advantageous as the brightness of the display devices 61-69 is changeable according to preference of a user.

In the above embodiment, a photometric value is calculated by the AE evaluator 156 according to image data generated by the CCD 102. Brightness of the EL display devices 61-69 is determined in the auto adjusting mode according to the photometric value. A problem may occur in that, if the CCD 102 is not driven, brightness of the display devices 61-69 may not be determined. To solve such a problem, the newest data of a photometric value obtained by the AE evaluator 156 can be written to a memory such as the SDRAM 116. Brightness of the display devices 61-69 can be determined according to the photometric value stored in the memory in a mode other than the photographing mode. Also, it is possible in a mode other than the photographing mode to drive the CCD 102 periodically, to obtain a photometric value. Furthermore, one brightness detecting sensor may be added instead of using the CCD 102 or the AE evaluator 156, and may detect brightness of the photographic field around the digital still camera 10. The brightness of the display devices 61-69 can be determined automatically in the auto adjusting mode according to the brightness of the photographic field measured by the brightness detecting sensor.

Note that the contrast of the EL display devices 61-69 may be used instead of brightness of those. The contrast is adjusted according to a result of the measured brightness of the field about the camera. The contrast, if the measured brightness is high, is set high, and if the measured brightness is low, is set low.

In the above embodiments, a portable instrument of the invention is either the digital still camera or the cellular telephone. However, a portable instrument of the invention may be any instrument, for example, PDA (Personal Digital Assistance), and the like.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A portable instrument in which plural operation modes are selectively settable, comprising:
a plurality of externally operable input units;
a function assignment table memory for storing a function assigning data table of relationship data between an operation mode, and a function assigned respectively to said input units among plural functions;
a controller for control in said function associated by said operation modes with one of said input units being operated according to said function assigning data table;
a plurality of display devices disposed in association with respectively said input units; and
a display control unit, responsive according to said function assigning data table, for causing one of said display devices associated with one of said input units to display information related to said function if said function is assigned thereto, and for keeping inactive a remaining one of said display devices associated with a remaining one of said input units if said remaining input unit is distinct from input units assigned with said functions.

2. A portable instrument as defined in claim 1, further comprising a selector for designating said operation mode selected among operation modes;
said display control unit refers to said function assigning data table according to said selected operation mode, to read said assigned function.

3. A portable instrument as defined in claim 2, wherein said portable instrument is a digital camera having an image sensor for outputting an image signal by photoelectrically converting object light of an object.

4. A portable instrument as defined in claim 2, wherein each of said input units includes:
a button block, shiftable between an open position and a closed position defined deeper than said open position, and having an outer surface where one of said display devices is positioned;
a detection switch for detecting shifting of said button block to said closed position.

5. A portable instrument as defined in claim 4, wherein each of said input units further includes:
a support mechanism for supporting said button block shiftably between said open and closed positions;
a bias mechanism for biasing said button block toward said open position.

6. A portable instrument as defined in claim 1, wherein said display devices are electroluminescent (EL) display devices.

7. A portable instrument as defined in claim 1, further comprising a monitor panel for displaying said operation mode selected among said operation modes.

8. A portable instrument as defined in claim 1, wherein said display control unit further controls brightness of said display devices according to said operation mode.

9. A portable instrument as defined in claim 8, wherein said plural operation modes include a normal operation mode and a power saving mode, and said display control unit controls said display devices to set brightness of displaying of said display devices in said power saving mode lower than brightness of displaying of said display devices in said normal operation mode.

10. A portable instrument as defined in claim 8, further comprising a mode selector, responsive when an unchanged state continues for a predetermined time in a normal operation mode, for setting said power saving mode.

11. A portable instrument as defined in claim 8, wherein information related to said function is constituted by alphanumeric character information or indicia and a background image disposed therewith;
said display control unit inverts brightness between said alphanumeric character information or indicia and said background image when said power saving mode is set instead of said normal operation mode.

12. A portable instrument as defined in claim 1, further comprising a brightness detecting sensor for detecting brightness of a field with ambient light;
said display control unit further controls brightness of displaying of said display devices according to said detected brightness of said field.

13. A portable instrument as defined in claim 12, wherein said portable instrument is a digital camera, and said brightness detecting sensor is constituted by an image sensor.

14. A portable instrument as defined in claim 12, wherein information related to said function is constituted by alphanumeric character information or indicia and a background image disposed therewith;
said display control unit controls brightness of at least one of said alphanumeric character information or indicia and said background image.

15. A portable instrument as defined in claim 12, further comprising a brightness adjuster, externally operable, for adjusting brightness of displaying of said display devices.

16. A digital camera in which plural operation modes are selectively settable, comprising:
an image sensor for outputting an image signal by photoelectrically converting object light of an object;
a plurality of externally operable input units;
a function assignment table memory for storing a function assigning data table of relationship data between an operation mode, and a function assigned respectively to said input units among plural functions;
a controller for control in said function associated by said operation modes with one of said input units being operated according to said function assigning data table;
a plurality of display devices disposed in association with respectively said input units; and
a display control unit, responsive according to said function assigning data table, for causing one of said display devices associated with one of said input units to display information related to said function if said function is assigned thereto, and for keeping inactive a remaining one of said display devices associated with a remaining one of said input units if said remaining input unit is distinct from input units assigned with said functions.

17. A digital camera as defined in claim 16, wherein said display control unit further controls brightness of displaying of said display devices according to said operation mode.

18. A digital camera as defined in claim 16, further comprising a brightness detecting sensor for detecting brightness of a field with ambient light;
said display control unit further controls brightness of displaying of said display devices according to said detected brightness of said field.

19. A digital camera as defined in claim 18, wherein said brightness detecting sensor is constituted by said image sensor.

20. A portable instrument in which plural operation modes are selectively settable, comprising:
a plurality of externally operable input units of which a function assigned according to an operation mode is changeable;
a plurality of display devices disposed on a surface of respectively said input units; and
a display control unit for causing each one of said display devices of a specified function being assigned specifically to display information of said specified function, and for controls brightness of displaying of said display devices according to said operation mode.

21. A portable instrument as defined in claim 20, wherein each of said input units includes:
a button block, shiftable between an open position and a closed position defined deeper than said open position, and having an outer surface where one of said display devices is positioned;
a detection switch for detecting shifting of said button block to said closed position.

22. A portable instrument as defined in claim 21, wherein said plural modes include a normal operation mode and a power saving mode, and said display control unit controls said display devices to set brightness of displaying of said display devices in said power saving mode lower than brightness of displaying of said display devices in said normal operation mode.

23. A portable instrument as defined in claim 21, further comprising a mode selector, responsive when an unchanged state continues for a predetermined time in a normal operation mode, for setting said power saving mode.

24. A portable instrument as defined in claim 21, wherein said information is constituted by alphanumeric character information or indicia and a background image disposed therewith;
said display control unit inverts brightness between said alphanumeric character information or indicia and said background image when said power saving mode is set instead of said normal operation mode.

25. A portable instrument in which plural operation modes are selectively settable, comprising:
a plurality of externally operable input units of which a function assigned according to an operation mode is changeable;
a plurality of display devices disposed on a surface of respectively said input units;
a brightness detecting sensor for detecting brightness of a field with ambient light;
a display control unit for causing each one of said display devices of a specified function being assigned specifically to display information of said specified function, and for controlling brightness of displaying of said display devices according to said detected brightness of said field.

26. A portable instrument as defined in claim 25, wherein each of said input units includes:
a button block, shiftable between an open position and a closed position defined deeper than said open position, and having an outer surface where one of said display devices is positioned;
a detection switch for detecting shifting of said button block to said closed position.

27. A portable instrument as defined in claim 26, further comprising an image sensor for outputting an image signal by photoelectrically converting object light of an object, and for constituting said brightness detecting sensor.

28. A portable instrument as defined in claim 26, wherein said information is constituted by alphanumeric character information or indicia and -a background image disposed therewith;
said display control unit controls brightness of at least one of said alphanumeric character information or indicia and said background image.

29. A portable instrument as defined in claim 26, further comprising a brightness adjuster, externally operable, for adjusting brightness of displaying of said display devices.
